(19) United States
(12) Patent Application Publication
(10) Pub. No.: US 2006/0080279 A1
(43) Pub. Date: Apr. 13, 2006

(54) Customized and customizable engineering calculation and project detailing system

(76) Inventor: Ryan K. Jones, Newport News, VA (US)

Correspondence Address: Alexander D. Raring;John H. Thomas, P.C., 536 Granite Avenue, Richmond, VA, 23226, US

(21) Appl. No.: 11/247,578

(22) Filed: Oct. 11, 2005

Related U.S. Application Data
(60) Provisional application No. 60/618,151, filed on Oct. 13, 2004.

(51) Int. Cl. G06F 17/30

(52) U.S. Cl. 707/1

(57) ABSTRACT

A customized and customizable structural calculation and project detailing system that is capable of producing a submittal package. The system operable with, but not limited to, structures incorporating cold-formed structural members. The system can output submittal packages based on minimal user input The application or system includes a comprehensive cold-formed database to perform calculations for structures built from cold-formed components. The database and an AI filter provide pattern recognition, automatic data saving, storage of known manufacturer data, and the like.

This application claims the benefit of U.S. Provisional Application Ser. No. 60/618,151 filed Oct. 13, 2004.

### FIELD OF THE INVENTION

The present invention relates generally to an engineering application and related tools. More specifically, it relates to a customized and customizable structural calculation and project detailing system capable of producing a submittal package.

### DESCRIPTION OF THE RELATED ART

Proposed structures are initially subject to structure design analysis that consists, at least in part, of engineering calculations done to test the adequacy of the structure in terms of safety, statutory regulations, feasibility, etc. The process of performing engineering calculations, in general, is an elaborate process requiring an architect, engineer, or contractor (an ‘AEC’ professional) to pull together information, data, equations, and/or other relevant information from a wide variety of sources. For instance, the professional must know or find the properties of various materials, the way such materials will act when formed into structural components, and a host of other facts. After recalling or locating the information, it must be properly transposed into the appropriate equations, which are often calculated by hand or with the aid of a calculator or other computer. Human error and the inherent complexity of the process make the resulting calculations prone to error, and locating the necessary information in disparate sources is a very time consuming procedure. After all the work is completed, any errors in the calculations can force a re-calculation, which only consumes more time. After the work is complete, it is often the case that there is no way to reuse the calculations done for the specific project at hand. Therefore, the effort must be duplicated for similar projects. Overall, it is a very inefficient process.

Engineers and designers not only keep track of all the necessary data, but they are often also required to create packages or submittals that detail the engineering project (or to be a part of a team that creates such a package). This project detailing documentation can include such things as estimates, diagrams (technical), figures, and spreadsheets. It is also expected that any calculations made in support of the project will be rewritten, along with formalized diagrams or other notes that might need to be revised into a presentable format. The skills necessary to assemble this documentation may not be in the engineer or designer's primary skill set. The tasks also duplicate earlier efforts and generally create additional inefficiencies in the engineering or calculation process.

The steps for a traditional engineering process are relatively well defined. The first major step is gather the latest manufacturer data and engineering specifications. This data forms the basis for later calculations. Using paper or a calculator, calculations are performed to determine the adequacy, functionality, safety, and the like of the proposed structure or project. The calculations are verified. If the results are incorrect, the calculations must be redone. Once the calculations “check out”, the engineer or designer will perform ancillary tasks based on their calculations (e.g., rewriting the calculations; drawing or redrawing diagrams; calculating a list of required materials; creating beam elevations, sectional, and detail views; calculating a cost quote; and the like). This work is completed several times for each project. Calculations from one project are not imported into a new project.

Therefore, there exists a need for a customized and customizable engineering calculation and detailing system. It is preferred that such a system would provide for the use of object-oriented algorithms, artificial intelligence (‘AI’), and a submittal engine so that an entire bid package, presentation, or project package could be generated with minimal initial input. Preferably, a single integrated system would be provided that does not rely upon third-party packages or software applications. The system would include data storage and retrieval, a graphical user interface, and other related tools. A structural calculation and detailing system in accordance with the present invention allows engineers to produce real-time results for faster and more accurate documentation than traditional methods. As described below, the present invention substantially departs from the conventional concepts and methods of the prior art, and it provides an original apparatus and/or method for improving the engineering calculation process.

### SUMMARY OF THE INVENTION

In accordance with the present invention, a customized and customizable structural calculation and detailing system is provided that facilitates engineering calculations and outputs related documentation including, among other things, related figures, schematics, calculations, and project expense estimates. The system is operable by structural engineers, architects, builders and related professionals to quickly and efficiently build detailed structures with accompanying structural calculations (shear, moment, deflection, etc.), technical diagrams, representative figures, and other pertinent submittal information (bill of materials, building site specifications, local regulations, project notes or facts, etc.). Overall, the system can take a structural engineering project from initial conception to the creation of a submittal package in a single integrated package.

The application of the present system allows modification of a structure or project to be updated in real-time as the user enters data or modifications. The user interfaces with the application via a wizard-like graphical user interface (‘GUI’). A wizard interface is an interactive help utility that guides the user through a potentially complex task. Wizards can be implemented as a sequence of dialog boxes that the user can move forward or backward through the process while answering queries or filling in details, as required.

Input into GUI can be then combined with information and data stored in a smart database. The smart database, in accordance with one preferred embodiment of the invention, can be defined as a programmatic entity comprised of 1) a relational database employing triggers, procedure, and DML and 2) high and/or low level native and/or non-native programmatic elements that handle the processing necessary to package and/or transport data between the defined system and the relational database. Output from the application backbone or a submittal engine can also be stored in the database, including drawing data, cost estimation data, notes, etc. In a preferred embodiment, any significant step in the input or output processes is recorded by the database. The database is remotely accessible.

The system provides substantially real-time structural analysis and detailing. As information is entered in the input process, calculations, diagrams, drawings, and/or other updates are represented instantaneously or near instantaneously (i.e., real-time). As such, users can modify or correct engineering information and data to see immediate results without having to move through a series of steps. These details of the project are gathered and assembled by a software submittal engine that converts information into a presentable, hard copy collection of documents that details the engineering project.

In yet another preferred embodiment, the system incorporates a cold-formed structural steel detail library that is stored in the database. The library contains the relevant information to conduct cold-formed structural steel engineering analysis. Therefore, the system also provides cold-formed structural calculations. A cold-formed structure consists of cold-formed building components. Cold-formed building components are made by the process of forming a structural section by bending sheet or strip metal (e.g., steel) in roll-forming machines without the use of heat. Specific algorithms for engineering calculations are applied to cold-formed structures. It is possible that these calculations can be shared between engineering projects. To that end, the present system includes pattern recognition and other artificial intelligence (‘AI’) features that enhance productivity. Namely, the system prevents repetitive user input by employing AI algorithms that detect many different engineering cases. Once a case is detected, the system either suggests an input or automatically and seamlessly provides the input.

The system provides further functionality related to engineering calculations. The submittal engine builds on the system's project-based approach and smart database storage features. The submittal engine is capable of providing a printed or displayed package of calculations, diagrams, drawings, bills of materials, cost estimates, and the like. The act of performing the necessary calculations can therefore be converted into a presentation or package based on entered data. The result can also be exported to a computer aided drawing (CAD) program. Engineering ‘office tools’ are also integrated into the present application.

As a customized and customizable structural steel calculation and detailing system, the present invention presents many advantages and features that result in a new methodology for inputting engineering data, calculating results, and outputting information in submittal form. The advantages of the present system will overcome a number of shortcomings recognized in the prior art. The system of the present invention provides for customized data requirements or field requirements at the user level. The system has standardized an engineering calculation and submittal package process. The system permits customization of data, entry fields, user access, and the like.

Other functions, advantages or features of the present invention will become obvious to the reader and it is intended that such items fall within the scope of the present invention. To the accomplishment of the above and related functions, advantages or features, this system's processes may be embodied in the form illustrated in the accompanying drawings, attention being called to the fact, however, that the drawings are only illustrative. Changes may be made in the specific processes as illustrated without leaving the scope of the invention. While the above highlights particular features of the invention in order that the detailed description thereof may be better understood, and in order that the present contribution to the art may be better appreciated, there are additional features of the invention that will be described hereinafter. Also, it is to be understood that the phraseology and terminology employed herein are for the purpose of the description and should not be regarded as limiting.

### BRIEF DESCRIPTION OF THE DRAWINGS

The present invention will be more fully appreciated as the same becomes better understood when considered in conjunction with the accompanying drawings wherein:

FIG. 1 is a flowchart depicting a manual engineering calculation process as known in the prior art;

FIG. 2 is a flowchart depicting efficient object oriented algorithms and artificial intelligence techniques operable to create an entire submittal package in accordance with the present invention;

FIG. 3 is a flowchart depicting the process steps of one preferred embodiment of the present invention;

FIG. 4 is a flowchart depicting additional process steps of a preferred embodiment of the present invention;

FIG. 5 is a flowchart depicting additional process steps of a preferred embodiment of the present invention;

FIG. 6 is a relatively high-level flowchart depiction of an artificial intelligence engine in accordance with one embodiment of the present invention; and

FIG. 7 is a sectional chart illustrating user inputs, application responses and application output in accordance with one embodiment of the present invention.

### DETAILED DESCRIPTION OF THE INVENTION

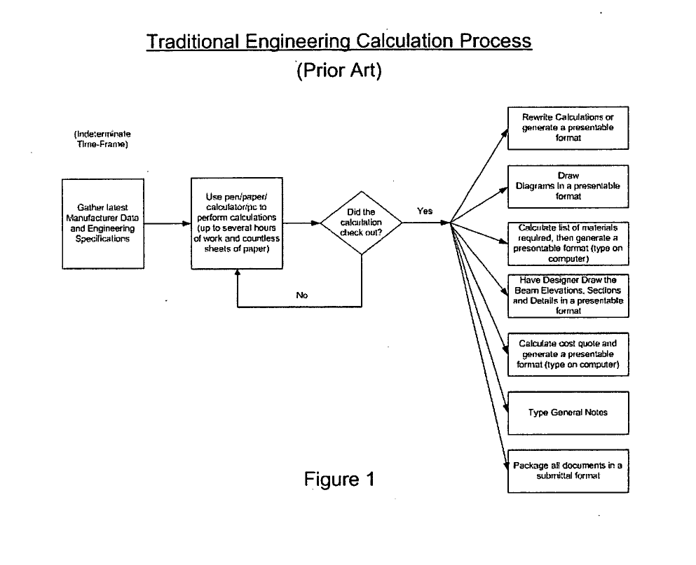

Turning now to a more detailed description of the present invention, there is first illustrated in FIG. 1 an embodiment of a known or traditional engineering calculation process. This flowchart is necessary and helpful in understanding the present invention. The exact and full methodologies for this type of manual engineering calculation need not be described in extensive detail herein inasmuch as such in-depth details are known to those skilled in the art, and the details are evident given the illustrations. Moreover, the process illustrated by the flowchart in FIG. 1 is merely an example. The present invention provides a system that simplifies and improves upon a wide-range of prior art engineering calculations and related tasks and need not be strictly associated with the illustrated prior art embodiment.

FIG. 1, being a known technique of an engineering calculation process, is thought to be self-explanatory. The flowchart begins with a broad process step of gathering the data and information necessary to proceed with the engineering calculations of a specific project. An engineer, or any person conducting relevant engineering calculations, takes the first action, which is to use pen and paper, a calculator, or a computer to perform calculations based on the information that was gathered. The calculation must be double checked for accuracy. Any errors in the calculations require that the calculation process step be repeated.

Once the calculations check out, the AEC or related professional creates and assembles a swath of documentation necessary to support or accompany the calculations. These documents are generated by hand or using distinct tools (i.e., software) that are not provided in an integrated package. The documents can include rewritten calculations that are presentable, diagrams of the project, a list(s) of materials required for the project, schematics, cost estimates, notes, or the like. The process must be completed for each engineering project. The project comprising the steps of conception to package creation will often be completed by at least three people: an engineer, a detailer, and a project manager. The separation of duties further increases the likelihood of errors. As one skilled in the art can surmise from the flowchart, the manual engineering calculation and detailing process can be carried out indefinitely pending accurate calculations. The manual system is highly labor intensive, prone to error, and inefficient.

Overall, the self-explanatory flowchart of FIG. 1 details the inefficiencies and potential stoppage points in a traditional engineering calculation and detailing process. This process is illustrated in order to understand the refined process and system of the present invention. The traditional process does not require further discussion here.

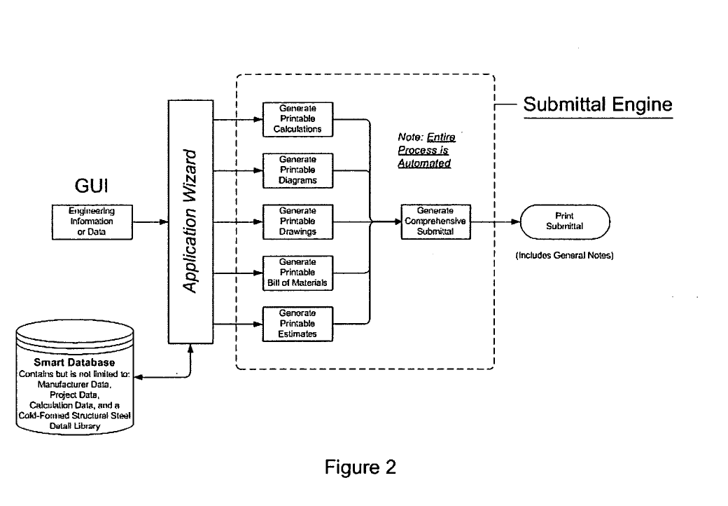

The present calculation and detailing system essentially moves an engineering project within an electronic environment through four stages: data entry, calculation, detail generation, and submittal creation. The stages can be defined numerous ways using various terminology, but one intended output is an entire submittal package that is generated with minimal user input. One skilled in the art will appreciate that the automated approach illustrated in FIG. 2 is highly efficient and accurate in comparison to traditional structural engineering methods. It is envisioned that an engineering project would be an entirely electronic operation from entry of data up and to the creation of a hard copy of a project submittal. However, it is understood that the communication of certain data, such as manufacturer's data or specifications, might be in non-electronic form until entered into the system. The present system is not limited to a fully electronic environment.

Examining FIG. 2 in more detail, there is illustrated an initial step for entering engineering information and/or data (manufacturer's specifications, materials specifications, proposed types and dimensions of structural components, etc.). Data entry and process options would be presented to a user through a wizard-like GUI. The data is passed to an application backbone. A user can also implement the system at this stage by defining the specific data requirements, manufacturer's information, material specifications, personnel, or other issues required to support the engineering project.

In one preferred embodiment, the GUI and application backbone are both located locally (i.e., on a user's computer). However, it is also envisioned that customized configurations within the system would allow a user to share system data over multiple and disparate in-house computer systems, effectively providing a centralizing and standardizing mode of communication. In other words, multiple parties may interact within a shared application backbone that is located locally or remotely. Customization of the system also extends to aesthetics as each user can be presented with a different electronic display or view of an on-going project. The view could be determined by a user-defined profile, a user's role in an organization, or other criteria View customization is generally known to one skilled in the art in relation to Internet web sites, software interfaces, graphical user interfaces, and the like.

Customization of the application can occur through the application's recognition of a defined user accessing the application. A “User Profile” would have a global effect on the input and output of the application. Customization could also occur manually or automatically during a user's session with an application. After a few iterations of the wizard, it is envisioned that the flow of engineering may be automatically customized to a specific user.

The language, choices, options, etc. necessary to process the engineering project may be restricted to choices offered by the customized GUI. The customizable view may limit actions available to the user. Different views and work lists can be assigned to multiple organizational departments or users. The engineering project is accessible by multiple users for different reasons. For instance, an administrator may access a project stored in the database via the backbone in order to provide technical support. In the event that multiple users access a project or the database remotely, communication protocols would be implemented that are known to one of skill in the art. The system would provide inherent security measures for local and remote access to a project stored in the smart database.

The system's backbone interacts with, or accepts data and instructions from, the GUI. The backbone is a programmatic element that connects portions of the application together. As such, the backbone manages database synchronization, multiple user database synchronization, project locking, wizard-page traversing, etc. The backbone imports or exports data to and from a smart database, as needed.

As briefly mentioned above, the backbone can also be accessed remotely. As such, in one preferred embodiment, it is envisioned that the GUI might be presented through an Internet portal (e.g., a website) to be accessed by the parties to the engineering project and detailing process. The website could be created using known website construction techniques. The portal could also be embodied as a client server application or other electronic exchange medium known to one skilled in the art. Effectively, the GUI or portal is a mechanism whereby parties may input their knowledge of an engineering project wherein that information is optionally combined with information supplied by the smart database. The application backbone connects the various application components. Underlying algorithms manipulate the data to perform engineering calculations, particularly cold-formed structural engineering calculations (discussed further below).

Data, algorithms, material and manufacturer specifications, and the like are stored in the database to be accessed via the backbone. The smart database is a programmatic entity that is comprised of 1) a relational database employing triggers, procedures, and DML and 2) high and/or low level native and/or non-native programmatic elements that handle the processing necessary to package and/or transport data between a defined system and the relational database. Based on the smart database, the system might provide pre-populated, project-specific fields. For instance, a class of projects could be created with the title “Trusses.” When a user selects that class of project, pre-populated and project specific fields would be available through the wizard-like GUI to be manipulated by the user. In this manner, a user can import project calculations from a previous project to either incorporate or edit the previous calculations. Thus, redundancy is eliminated or reduced between multiple projects.

Output from the application backbone can also be stored in the database, including drawing data, cost estimation data, notes, etc. In a preferred embodiment, any significant step in the input or output processes is recorded by the database. Communication between the database and the backbone is two-way communication. Data can flow either way between the database and backbone. Data drawn from the backbone can be pre-populated into fields in the user's GUI.

As is further illustrated in FIG. 2, the application backbone can output data and calculation results to a submittal engine. The submittal engine generates printable calculations, printable diagrams, printable drawings, a printable bill of materials, a printable cost estimate and the like. These documents are gathered in order to document the engineering project. The project documents form a comprehensive submittal. The submittal engine outputs (i.e., prints) this submittal. Work that was typically manually completed after engineering calculations were completed can now be automatically launched. Moreover, changes in any of the submittal engine documents can be electronically viewed in real time as changes are submitted to the application backbone. Effectively, an engineer can make running changes to an engineering project and see the effect of those changes near instantaneously, both visually and mathematically. The dimensions, materials, and or other features of a structural engineering project can be compared and examined. The user selects from views showing deflection diagrams, structural drawings, close up detailing (like structural member connections), notes, calculations and the like. If a structure or member creates a “fail” condition in the structure, that result is immediately accessible to the user.

Again, the system is specifically programmed to accommodate structural engineering projects built with cold-formed components. These types of components, often made of steel, are constructed from a process of forming a structural section by bending sheet or strip metal (e.g., steel) in roll-forming machines without the use of heat The method of forming the structural components requires specific algorithms that analyze and design a structure built from such components. A cold-formed structural steel library containing pertinent information, data and equations is stored in the smart database to be accessed as needed. Information about structural connections, sectional details, and/or other details that might be relevant to a particular engineering project can be contained in the library. The format of the elements in the library could be an AutoCAD™ script, bitmap, or other related data formats. This data is managed by the smart database.

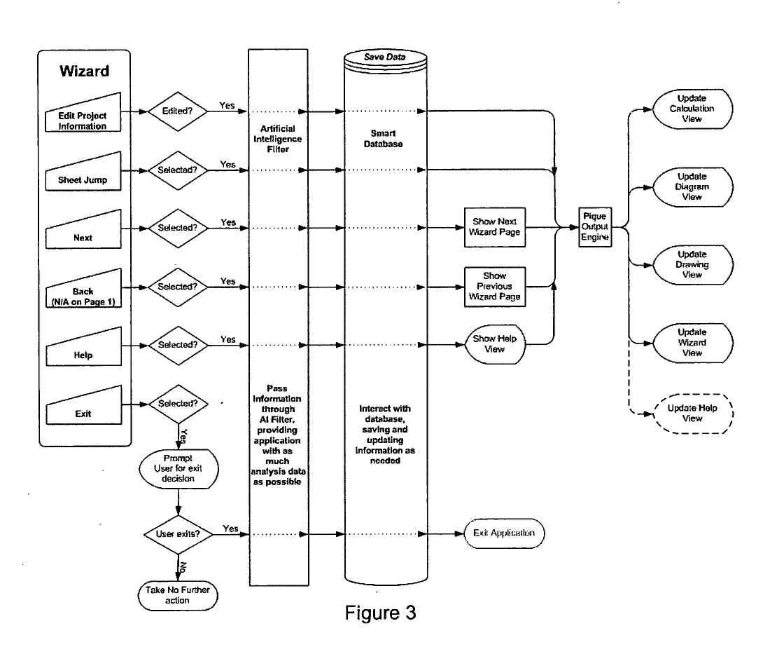

Turning now to FIG. 3, a flowchart illustrates the process and method of the present invention in greater detail. The flowchart is more specifically directed to the process that begins with a user interfacing with an interface wizard (i.e., a GUI) through to the creation of project packaging or project views. The choices illustrated in the box clearly labeled “Wizard” are examples of options that could be presented to a user. Other options are, of course, possible, as one skilled in the art would appreciate. As is self-explanatory from examining FIG. 3, a user chooses from a set of options including: to edit the project information, sheet jump, move to the ‘next’ process step, ‘back’ up to a previous process step, solicit help, or exit the system. Every option besides “exit” moves the process into an AI filter.

The AI filter is a structured set of algorithms that analyze user input and seamlessly react to the results of the analysis. The AI will “learn” a user's patterns through repeated use of the application. The AI filter will also be customizable. Overall, the “artificial intelligence” determines what information in the database might be necessary or useful to the selected task. The AI can also determine what information needs to be saved to the database for later use. The feature acts as an auto-save function. The AI filter is capable of making a decision and then causing the database to act on that decision.

The user's selection to edit the project or ‘sheet jump’ will lead to the project information being passed to the submittal or output engine. The sheet jump option allows a user to skip to a previously created sheet and places the user in an edit mode. The choices also provide a user with the options of moving forward or back in the project process or to request help. The next and back options move to generally move to different process steps (not illustrated). It is also possible to loop a specific process step a specific number of times to create multiple identical or related structural sections (not illustrated).

The results of the addition of any new or edited information are instantly displayed in real-time. For example, a user can edit numbers in a calculation and the application will display the changes in whichever views the user has selected to view. Thus, the system will offer at least running views of the calculation results, diagram views, drawings views, and wizard views.

The ‘exit’ selection, as clearly illustrated, requires a secondary prompt to confirm that the user wishes to exit the program. If the user confirms the exit request, the AI filter determines which information needs to be saved, the information is saved to the database, and then application or system is exited Instead, the user can decline the exit prompt. The user would then be relocated to the wizard or presented with several choices to move the process (not illustrated).

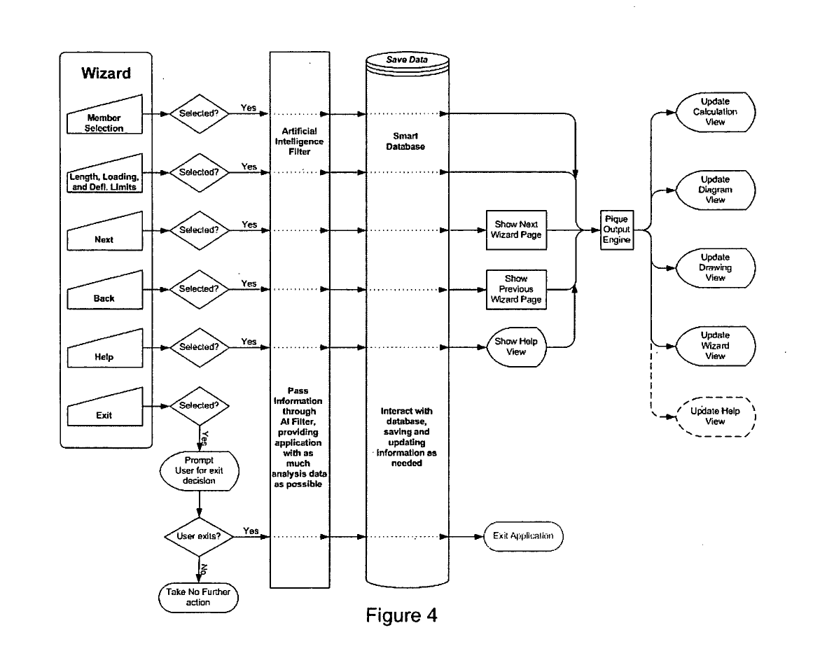

FIG. 4 is another flowchart illustrating the process and method of the present invention in greater detail. The flowchart is, like FIG. 3, directed to the process that begins with a user interfacing with an interface wizard (i.e., a GUI) through to the creation of a project package or a project view. The choices illustrated in the box clearly labeled “Wizard” are examples of options that could be presented to a user. Other options are, of course, possible, as one skilled in the art would appreciate. The process works as described above in FIG. 3. Here, however, additional information is requested from the user. Namely, the system requests that the user selects the members or components used in the structure. The system also requests length, loading and deflection limits for the various components.

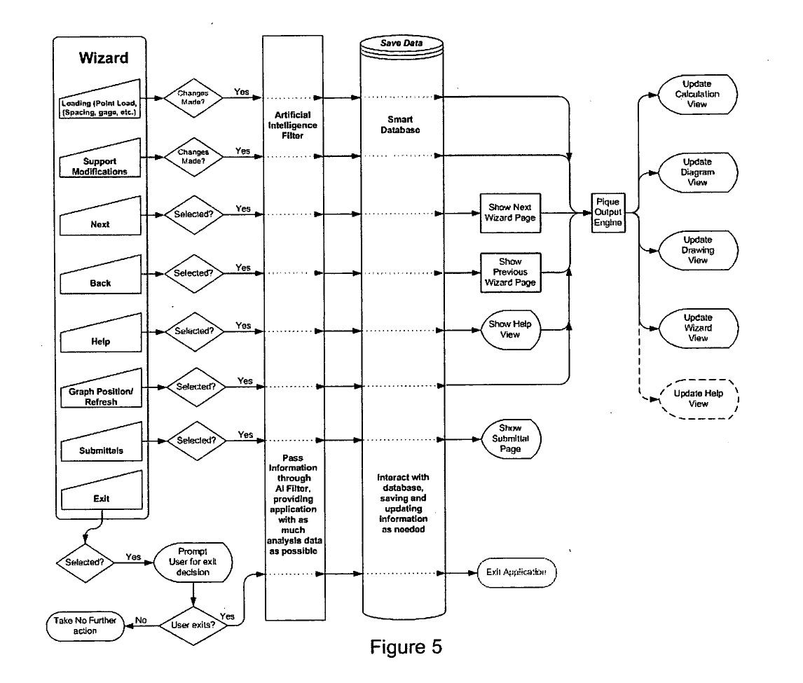

The user can move from one process to another by selecting the “next” and “back” options in the wizard. Although the connection is not shown in the Figures, the “next” and “back” option can be selected to move through the wizard choices. For instance, selecting “next” in FIG. 4 could then present the additional wizard options clearly illustrated in FIG. 5. Specific discussion of FIG. 5 is not necessary as the process mimics the process steps of FIGS. 3 and 4. Additional process steps would of course be available.

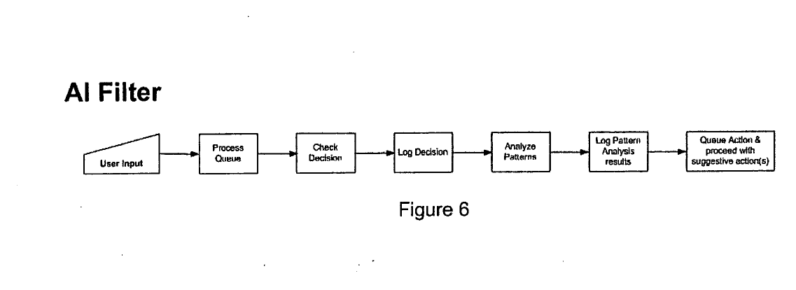

FIG. 6 is a flowchart representing the general operation of the AI filter. The filter provides pattern recognition and other AI features. For instance, the system is designed to prevent repetitive user input by employing AI algorithms that detect many types of engineering cases. When a case is recognized, information can be pulled from the database to prepopulate fields in the wizard.

The AI filter is responsive to a user; therefore, the first step in FIG. 6 is an action requiring user input. The input enters a process queue that renders a decision as to the prior presence or relevance of the input. The decision is reviewed and then logged. Patterns in input are analyzed. This analysis is also logged. Finally, the filter queues an action and proceeds with suggestion.

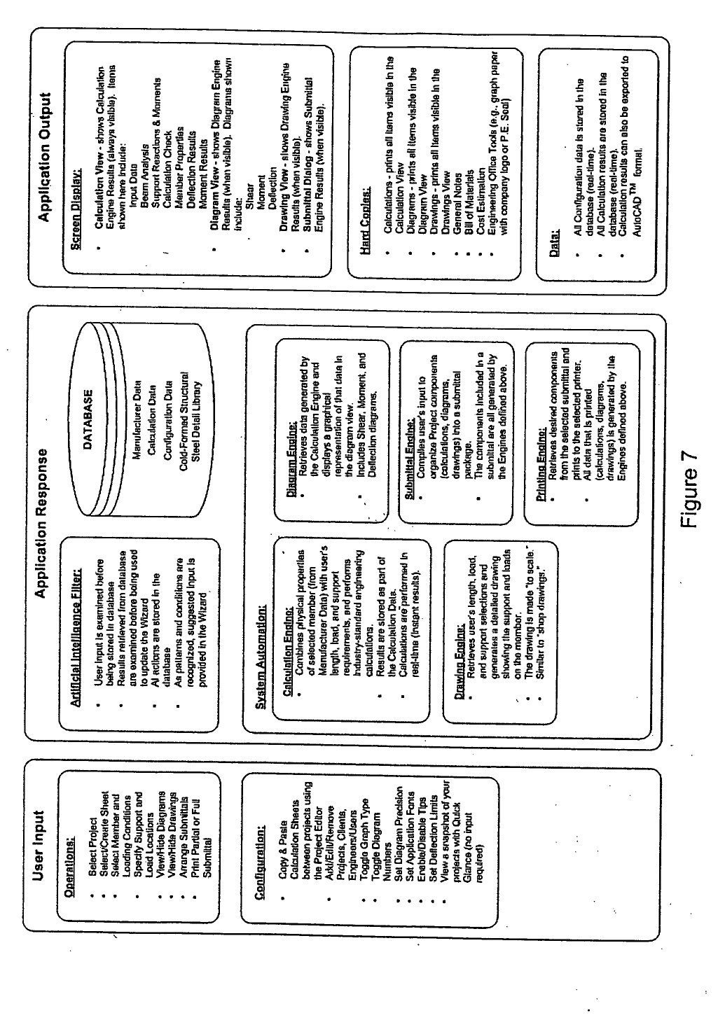

FIG. 7 is an illustrated overview or roadmap of the system. The roadmap would facilitate the coding and assembly of at least one embodiment of the present system by a software programmer. User input, application responses, and application output are all illustrated in distinct sections of the graph.

In use, the application or system of the present invention is a customized and customizable, project-based, structural calculation, diagramming, and detailing system. Users can quickly and efficiently build detailed structural sections, particularly structural steel sections, with accompanying structural calculations, technical diagrams, structurally representative figures, and other pertinent submittal information. The application provides real-time results derived from information supplied to a wizard-like GUI. Therefore, during each build session, the user is able to view real-time calculations, diagrams, or other related information to determine if the actual design or structure input satisfies building codes or other requirements. When finished, the user can print an entire submittal package.

The system stores applicable statutory requirements in the system database. The applicable requirements (e.g., the state and local requirements governing the space for the intended project) are imposed on project records. The system can therefore track individual projects and incorporate the governing local, state, and federal laws related to structures and ensure that project structures are in compliance with those laws. Projects that are not in compliance based on the system's information are flagged, grouped, or otherwise highlighted for attention. Therefore, the user is advised if the project is not in compliance with statutory requirements. Date stamps will record the progress of projects.

Although the present invention has been described in terms of a preferred embodiment, it will be understood that numerous variations and modifications may be made without departing from the invention. Such variations and modifications will become apparent and obvious to one skilled in the art, and all equivalent relationships to those illustrated in the drawings and described in the specification are intended to be encompassed by the present invention. Other embodiments are intended to be covered by the scope of the invention. Thus, it is to be understood that within the scope of the appended claims, the invention may be practiced otherwise than as specifically described above.

What is claimed is:

1. A method for performing structural calculations and creating engineering project details comprising a plurality of computer executable instructions for processing by a computer, the instructions including instructions for:
entering engineering information into an application backbone,
supplying data from a smart database to the application backbone,
performing engineering calculations;
passing information through an AI filter;
saving engineering information and calculations identified by the AI filter to the smart database;
outputting data from the backbone to a submittal engine;
displaying engineering details based on the data outputted to the submittal engine; and
creating a submittal package produced from the submittal engine details.

2. The method of claim 1, wherein the step of entering engineering information includes a wizard-like graphical user interface.

3. The method of claim 1, wherein the step of performing engineering calculations further includes the step of performing calculations for a structure built in part from cold-formed structural steel building components.

4. The method of claim 3, further including the step of integrating the contents of a cold-formed structural steel library into the smart database.

5. The method of claim 1, wherein the submittal package includes a printed copy of at least one of the items to be selected from the group comprising: a calculation view illustrating calculation results, diagram view illustrating mechanical forces on the building components of the proposed structure, a drawing view illustrating a representative view of the proposed structure, a bill of materials related to the proposed structure, and a cost estimation related to the proposed structure.

6. The method of claim 1, wherein the smart database includes statutory requirements for structural projects wherein the applicable statutory requirements are applied to an on-going project in the application backbone, and wherein a user is advised if the structure project does not meet the applicable requirements.

7. The method of claim 1, wherein the AI filter is capable of making a decision and then causing the smart database to act on that decision, the AI filter comprising a structured set of algorithms that analyze user input and seamlessly react to the results of the analysis and wherein the AI determines what information in the smart database might be necessary or useful to the selected task and further what information needs to be stored to the smart database.

8. The method of claim 1, wherein the smart database is a programmatic entity comprising a relational database employing triggers, procedures, and DML and high and/or low level native and/or non-native programmatic elements that handle the processing necessary to supply data between the backbone and the relational database.

9. The method of claim 8, wherein the steps entering engineering information into an application backbone and supplying data from a smart database to the application backbone further include the step of pre-populating project-specific data fields with data contained in the smart database.
